(19) United States
(12) Patent Application Publication
(10) Pub. No.: US 2014/0093610 A1
(43) Pub. Date: Apr. 3, 2014

(54) METHOD FOR MANUFACTURING A NON-EFFERVESCENT BEVERAGE COMPRISING A CLEAR SPIRIT MIXED WITH A FLUORESCENT AGENT

(71) Applicant: Richard Virenque, Luxembourg (LU)

(72) Inventor: Richard Virenque, Luxembourg (LU)

(73) Assignee: Ice Promotion S.A., Luxembourg (LU)

(21) Appl. No.: 14/118,872

(22) PCT Filed: May 20, 2011
(86) PCT No.: PCT/IB2011/001088

§ 371 Date: Nov. 19, 2013

(51) Int. Cl. C12G 3/04

(52) U.S. Cl. CPC C12G 3/04
USPC 426/11; 426/250; 426/592

(57) ABSTRACT

The present invention relates to a method for manufacturing a non-effervescent alcoholic beverage, which consists of mixing a non-effervescent clear spirit with an agent that gives said beverage a fluorescent colour when exposed to ultraviolet light, said agent being riboflavin or quinine, said beverage being subsequently packaged, characterised in that: when said spirit is obtained by distillation and has an alcohol content of more than 20%, riboflavin is added in a proportion of less than 3 mg/100 ml or quinine is added in a proportion of less than 60 ppm; and when said spirit is obtained by fermentation and has an alcohol content of less than 20%, riboflavin is added in a proportion of more than 5 mg/100 ml or quinine is added in a proportion of 100 ppm.

### TECHNICAL FIELD OF THE INVENTION

The aim of the invention is a manufacturing process for a non-effervescent beverage comprising of a clear spirit mixed with a fluorescent agent.

The invention relates to a method for manufacturing non-effervescent alcoholic beverages of the clear spirit type, which are ready-to-use and for direct consumption. More specifically, the invention relates to effervescent alcoholic beverages with a visual appearance that is particularly attractive to consumers.

### STATE OF THE ART

Non-effervescent alcoholic beverages, of the clear spirit type, are well known in the prior art. The best known clear spirits are vodka, tequila, mezcal, triple-sec, white rum, aquavit, sake, etc.

The visual appearance of a beverage has an undeniably strong influence on the attraction it may have for the consumer. Therefore, with some exceptions, it can be found that, today, for the same type of clear spirit, it is difficult to determine the source of the beverage once it is poured into a glass. Visually, one brand of vodka looks much like another brand of vodka. The same applies to white rum or sake. Only their packaging (bottles, kegs, cans, etc.) enables the consumer to identify the brand of the beverage being consumed.

Faced with this issue, the main technical problem that the invention aims to resolve is to propose a technique enabling easy recognition of the brand of a non-effervescent alcoholic beverage, irrespective of its packaging.

Another objective of the invention is to propose a manufacturing process that will maximise the luminous effect of the beverage, depending on the type of clear spirit used in the formulation.

### DISCLOSURE OF THE INVENTION

The solution proposed by the invention is a process to manufacture a non-effervescent alcoholic beverage (e.g. without bubbles or “flat”) consisting of a non-effervescent clear spirit mixed with an agent, possibly a colorant, which gives said beverage a fluorescent colour when exposed to ultra-violet light, said agent being from the riboflavin or quinine group.

More specifically, the invention relates to a manufacturing process for a non-effervescent alcoholic beverage, which consists of mixing a non-effervescent clear spirit with an agent that gives said beverage a fluorescent colour when exposed to ultra-violet light, said agent being riboflavin or quinine, said beverage being subsequently packaged. This process is notable in that:
when said spirit is obtained by distillation and has an alcohol content of more than 20%, the addition of:
   riboflavin is in a proportion of less than 3 mg/100 ml
   quinine is in a proportion of less than 60 ppm,
or when said spirit is obtained by fermentation and has an alcohol content of less than 20%, the addition of:
   riboflavin is in a proportion of more than 5 mg/100 ml
   quinine is in a proportion of 100 ppm

The use of such a fluorescent agent, added in a proportion suited to the type of spirit, results in a particularly attractive and fun effect for the consumer. For example, in places equipped with ultra-violet light or “black” light” (usually in bars, clubs or other nightclubs) the process produces a fluorescent beverage that stands out from other beverages typically consumed. It is therefore easy to recognise the beverage that is the subject of the invention when it is poured into a glass, irrespective of its packaging.

The inventor also discovered, by surprise, that the combination of a non-effervescent clear spirit and/or riboflavin and/or quinine, enhanced the luminous effect obtained in the presence of ultra-violet light and/or enabled a unique and particularly attractive visual effect to be obtained. This can be attributed to the ethanol contained in the clear spirit which has a specific action on the fluorescent agent.

Other benefits and characteristics of the invention will become more apparent from reading the description of a preferred embodiment thereof, which shall follow.

### EMBODIMENT OF THE INVENTION

The beverage that is the subject of the invention is a ready-to-use beverage, intended to be stored in bottles, kegs, cans or other types of containers. The size of the container shall vary: 17 ml, 125 ml, 252 ml, 500 ml, etc.

Typically, the beverage that is the subject of the invention is a non-effervescent alcoholic beverage (with an alcohol content of between 6% and 55%), comprising a non-effervescent clear spirit, of the vodka, tequila, mezcal, triple-sec, white rum, aquavit, sake, etc, type and to which is added an agent giving said beverage a fluorescent colour when exposed to ultra-violet light (or “black” light). Such an agent absorbs the ultra-violet light and re-diffuses it in the form of visible coloured light.

The fluorescent agent used is non-toxic to humans and is compatible with food products. The inventor observed that among several existing fluorescent agents, riboflavin and/or quinine were those which produced the most attractive visual effect, when mixed with a non-effervescent clear spirit. The ethanol contained in the white alcohol appears to influence the fluorescent effect of these agents. Riboflavin is preferential, but not necessarily associated with a food colorant (for example, Brilliant Blue E133, Red E129, orange/yellow E110, etc.)

The following proportions are used advantageously:
Between 2 mg/ml and 7 mg/ml of riboflavin and between 0.005 mg/100 ml and 0.8 mg/ml of food colorant, if the latter is used.
Between 20 ppm and 200 ppm of quinine.

The inventor observed that for certain clear spirits, depending on whether this spirit is obtained by distillation (such as vodka) or by fermentation (such as sake) and depending on the alcohol content, the visual effect obtained can vary depending on the proportion of the fluorescent agent used. For example for clear spirits obtained by fermentation and with a relatively low alcohol content (for example, less than 20%), the proportion of riboflavin may be greater than 5 mg/ml and the proportion of quinine greater than 100 ppm. For clear spirits obtained by distillation and with a relatively strong alcohol content (for example, more than 20%), the proportion of riboflavin can be less than 3 mg/ml and the proportion of quinine less than 60 ppm. These specific proportions depend on the type of clear spirit used, enabling the luminous effect to be enhanced.

To manufacture the beverages that are the subject of the invention, simply add the aforementioned fluorescent agent (in liquid or powder form) to the clear spirit and mix before, during or after the packaging stage.

1. Manufacturing process for a non-effervescent alcoholic beverage, which consists of mixing a non-effervescent clear spirit with an agent giving said beverage a fluorescent colour when exposed to ultra-violet light, said agent being riboflavin or quinine, characterised by the fact that:
when said spirit is obtained by distillation and has an alcohol content of more than 20%, the addition of:
riboflavin is in a proportion of less than 3 mg/100 ml
quinine is in a proportion of less than 60 ppm,
or when said spirit is obtained by fermentation and has an alcohol content of less 20%, the addition of:
riboflavin is in a proportion of more than 5 mg/100 ml
quinine is in a proportion of 100 ppm

2. Process in accordance with claim 1, in which riboflavin is associated to a food colorant added in a proportion of between 0.005 mg/ml and 0.9 mg/ml.

3. Process in accordance with claim 1, in which the fluorescent agent is mixed with a non-effervescent clear spirit chosen from the following group: vodka, tequila, mezcal, triple-sec, whiter rum, aquavit or sake.

4. Process in accordance with claim 1, in which the fluorescent agent is added to the clear spirit and mixed before a packaging stage.

5. Process in accordance with claim 1, in which the fluorescent agent is added to the clear spirit and mixed during a packaging stage.

6. Process in accordance with claim 1, in which the fluorescent agent is added to the clear spirit and mixed after a packaging stage.

7. A beverage obtained using the process in accordance with claim 1, said beverage being stored in a bottle, keg or can type container.
